(19) United States
(12) Patent Application Publication
(10) Pub. No.: US 2018/0002002 A1
(43) Pub. Date: Jan. 4, 2018

(54) ROTOR ASSEMBLY INCLUDING A ONE PIECE MOLDING ROTOR HUB

(71) Applicant: SIKORSKY AIRCRAFT CORPORATION, STRATFORD, CT (US)

(72) Inventors: BRYAN KENNETH BASKIN, ARLINGTON, TX (US); RON WILLIAM WALDO, NORTH RICHLAND HILLS, TX (US)

(21) Appl. No.: 14/999,920

(22) Filed: Dec. 12, 2016

Related U.S. Application Data
(60) Provisional application No. 62/298,217, filed on Feb. 22, 2016.

(51) Int. Cl. B64C 27/14; B64C 27/10

(52) U.S. Cl. CPC B64C 27/14; B64C 27/10

(57) ABSTRACT

A rotor assembly for use with rotor blades and a drive shaft includes a one-piece molded rotor hub having a central hub and a plurality of hollow spindles integrally molded with and extending radially outwardly of the central hub to which rotor blades are attachable. The central hub includes a hollow interior that is receptive to a drive shaft configured to rotate the one-piece molded rotor hub.

### CROSS-REFERENCE TO RELATED APPLICATIONS

The present application claims priority to U.S. Provisional Application No. 62/298,217, filed on Feb. 22, 2016, the contents of which are incorporated by reference herein in its entirety.

### STATEMENT OF FEDERAL SUPPORT

This invention was made with Government support under Agreement No. W911W6-13-2-0003 for the Joint Multi-Role Technology Demonstrator Phase I-Air Vehicle Development program. The Government has certain rights in the invention.

### BACKGROUND

Exemplary embodiments pertain to the art of aircraft and, more particularly, to a one-piece molded rotor hub for an aircraft.

A fixed wing aircraft may include one or more propellers that provide energy for forward movement. Rotary wing aircraft include one or more rotors that provide lift, yaw control, and/or forward movement. More specifically, rotary wing aircraft include a main rotor assembly that provides lift and a tail rotor assembly that provides yaw control or, in the case of a propulsor, energy for forward movement. In some cases, both the main rotor assembly and the propulsor include dual rotor assemblies. The dual rotor assemblies may represent counter rotating rotors or co-rotating rotors.

### BRIEF DESCRIPTION

Disclosed is a rotor assembly for use with rotor blades and a drive shaft includes a one-piece molded rotor hub having a central hub and a plurality of hollow spindles integrally molded with and extending radially outwardly of the central hub to which rotor blades are attachable. The central hub includes a hollow interior that is receptive to a drive shaft configured to rotate the one-piece molded rotor hub.

In addition to one or more of the features described above or below, or as an alternative, further embodiments could include a tension torsion strap extending through each of the plurality of hollow spindles, the tension torsion strap including a first end operatively connected to the central hub and a second end projecting proudly of the corresponding one of the plurality of hollow spindles.

In addition to one or more of the features described above or below, or as an alternative, further embodiments could include a plurality of openings extending through the central hub, each of the plurality of openings being arranged along a central axis of a corresponding one of the plurality of hollow spindles.

In addition to one or more of the features described above or below, or as an alternative, further embodiments could include a pin member extending through each of the plurality of openings and operatively connected to the first end of the tension strap arranged in the corresponding one of the plurality of hollow spindles.

In addition to one or more of the features described above or below, or as an alternative, further embodiments could include wherein the rotor blade is operatively coupled to the second end of the tension torsion strap.

In addition to one or more of the features described above or below, or as an alternative, further embodiments could include at least one sleeve installed over each of the plurality of hollow spindles.

In addition to one or more of the features described above or below, or as an alternative, further embodiments could include wherein the at least one sleeve is formed from a different material from that which forms the one-piece molded rotor hub.

In addition to one or more of the features described above or below, or as an alternative, further embodiments could include a clam shell connected to the one-piece molded rotor hub and having openings through each the plurality of hollow spindles extend, the clam shell having a fastening system which connects the one-piece molded rotor hub to the drive shaft.

In addition to one or more of the features described above or below, or as an alternative, further embodiments could include wherein the one-piece molded rotor hub assembly is produced using formed from a resin composite.

In addition to one or more of the features described above or below, or as an alternative, further embodiments could include wherein the resin composite includes one of graphite and an epoxy, and the one-piece molded rotor hub and plurality of hollow spindles are formed as a single molded rotor assembly using a resin transfer molding process.

In addition to one or more of the features described above or below, or as an alternative, further embodiments could include wherein the one-piece molded rotor hub and spindles are produced using a process which produces an integrally formed rotor hub.

Also disclosed is an aircraft including an airframe, a power source, a drive member operatively connected to the power source, and a rotor assembly operatively connected to the drive member. The rotor assembly a one-piece molded rotor hub having a central hub and a plurality of hollow spindles integrally molded with and extending radially outwardly of the central hub to which rotor blades are attachable. The central hub includes a hollow interior that is receptive to a drive shaft coupled to the drive member.

In addition to one or more of the features described above or below, or as an alternative, further embodiments could include a tension torsion strap extending through each of the plurality of hollow spindles, the tension torsion strap including a first end operatively connected to the central hub and a second end projecting proudly of the corresponding one of the plurality of hollow spindles.

In addition to one or more of the features described above or below, or as an alternative, further embodiments could include a plurality of openings extending through the central hub, each of the plurality of openings being arranged along a central axis of a corresponding one of the plurality of hollow spindles, a pin member extending through each of the plurality of openings and operatively connected to the first end of the tension strap arranged in the corresponding one of the plurality of hollow spindles, and a rotor blade operatively connected to the second end of the tension torsion strap.

In addition to one or more of the features described above or below, or as an alternative, further embodiments could include a clam shell connected to the one-piece molded rotor hub and having openings through each the spindles extend, the clam shell having a fastening system which connects the rotor hub to the drive shaft.

### BRIEF DESCRIPTION OF THE DRAWINGS

The following descriptions should not be considered limiting in any way. With reference to the accompanying drawings, like elements are numbered alike:

FIG. 1 depicts a rotary wing aircraft including a rotor assembly having a one-piece molded hub, in accordance with an exemplary embodiment;

FIG. 2 is a perspective view of a rotary wing aircraft of FIG. 1, in accordance with an exemplary embodiment;

FIG. 3 is a partial perspective view of the rotor assembly, in accordance with an aspect of an exemplary embodiment;

FIG. 4 is a perspective view of the one-piece molded rotor hub, in accordance with an aspect of an exemplary embodiment, and

FIG. 5 is a partial cross-sectional view of the rotor assembly, in accordance with an aspect of an exemplary embodiment.

### DETAILED DESCRIPTION

A detailed description of one or more embodiments of the disclosed apparatus and method are presented herein by way of exemplification and not limitation with reference to the Figures.

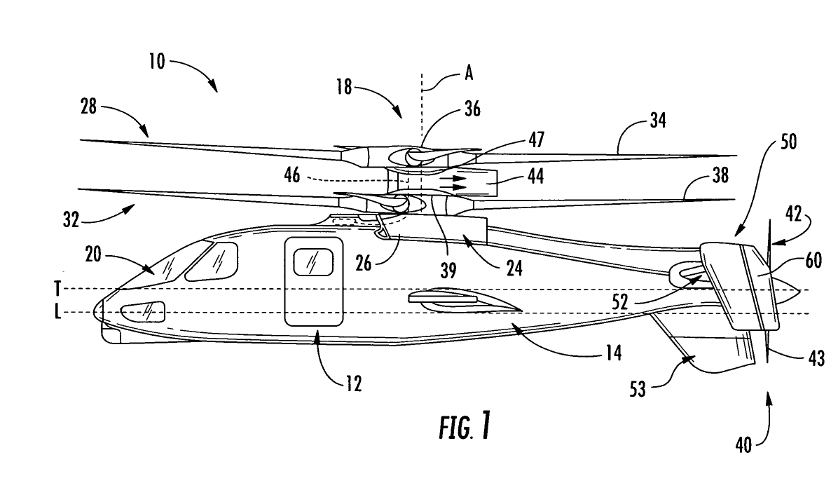

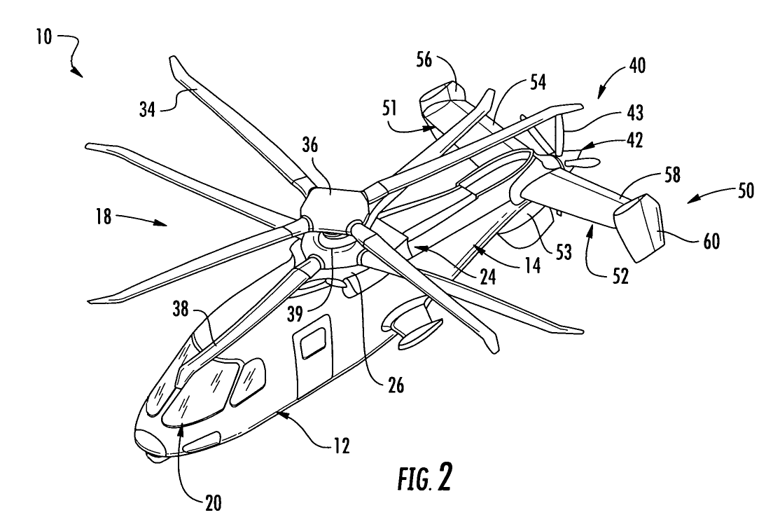

FIGS. 1 and 2 depict an exemplary embodiment of a rotary wing, vertical takeoff and landing (VTOL) aircraft 10. Aircraft 10 includes an airframe or fuselage 12 having a plurality of surfaces (not separately labeled) with an extending tail 14. A coaxial main rotor assembly 18 is located at the fuselage 12 and rotates about a main rotor axis, A. In an exemplary embodiment, the fuselage 12 includes a cockpit 20 having two seats for flight crew (e.g., pilot and co-pilot) and six seats for passengers (not shown). Main rotor assembly 18 is driven by a power source, for example, one or more engines 24, via a gearbox 26. Main rotor assembly 18 includes an upper rotor assembly 28 that may be driven in a first direction (e.g., counter-clockwise) about the main rotor axis, A, and a lower rotor assembly 32 that may be driven in a second direction (e.g., clockwise) about the main rotor axis, A, opposite to the first direction (i.e., counter rotating rotors). Of course, it should be understood that upper and lower rotor assemblies 28 and 32 may be driven in the same direction.

In accordance with an exemplary embodiment, upper rotor assembly 28 includes a first plurality of rotor blades 34 supported by a first or upper rotor hub 36. Lower rotor assembly 32 includes a second plurality of rotor blades 38 supported by a second, or lower rotor hub 39. In some embodiments, aircraft 10 may include a translational thrust system or propulsor 40 having a rotor or propeller assembly 42 located at extending tail 14 to provide translational thrust (forward or rearward) for aircraft 10. Propeller assembly 42 includes a plurality of blades 43.

Main rotor assembly 18 also includes a shaft fairing 44 generally located between and around the upper and lower rotor assemblies 28 and 32 such that lower rotor hub 39 may be at least partially contained therein. Shaft fairing 44 extends about a rotor shaft 46 operatively connecting upper rotor assembly 28 and engine(s) 24. Shaft fairing 44 extends between lower hub 39 and an upper hub member 47 arranged inwardly of upper rotor assembly 28 and operates to reduce drag which might otherwise exist at rotor shaft 46. First plurality of rotor blades 34 may be connected to upper rotor hub 36 in a hingeless manner, also referred to as a rigid rotor system. Similarly, second plurality of rotor blades 38 may be connected to lower rotor hub 39 in a hingeless manner. Although a particular aircraft configuration is illustrated in this non-limiting embodiment, other rotary wing aircraft will also benefit from embodiments of the invention. Although, the dual rotor system is depicted as coaxial, embodiments include dual rotor aircraft having non-coaxial rotors. Further, while a particular aircraft configuration is illustrated in this non-limiting embodiment, other rotary wing aircraft will also benefit from embodiments of the invention, such as those not including a fairing. Moreover, aspects can be used in non-rotary wing aircraft, including fixed wing aircraft and tilt wing aircraft using rotor blades and/or propellers, and can be used in maritime propulsion systems, wind turbines and the like.

Propeller assembly 42, or translational thrust system 40, is connected to, and driven by, the engine 24 via the gearbox 26. Translational thrust system 40 may be mounted to the rear of the fuselage 12 with a translational thrust axis, T, oriented substantially horizontal and parallel to the aircraft longitudinal axis, L, to provide thrust for high-speed flight. The term “parallel” should be understood to include a translational thrust axis that is coincident with the longitudinal axis. Translational thrust axis, T, corresponds to the axis of rotation of propeller assembly 42. While shown in the context of a pusher-prop configuration, it is understood that the propeller assembly 42 could also be a more conventional puller prop or could be variably facing so as to provide yaw control in addition to, or instead of, translational thrust. It should be further understood that any such system or other translational thrust systems may alternatively or additionally be utilized. Alternative translational thrust systems may include different propulsion forms, such as a jet engine.

In accordance with an aspect of an exemplary embodiment, propeller assembly 42 may include propeller blades 43 having a variable pitch. More specifically, the pitch of propeller blades 43 may be altered to change the direction of thrust (e.g., forward or rearward). In accordance with another aspect of an exemplary embodiment, extended tail 14 includes a tail section 50 including starboard and port horizontal stabilizers 51 and 52. Tail section 50 also includes a vertical stabilizer 53 that extends downward from extending tail 14. Starboard horizontal stabilizer 51 includes a starboard active elevator 54 and a starboard active rudder 56. Similarly, port horizontal stabilizer 52 includes a port active elevator 58 and a port active rudder 60. Elevators 54 and 58 and rudders 56 and 60 act as controllable surfaces, e.g., surfaces that alter a flight path/characteristics of aircraft 10.

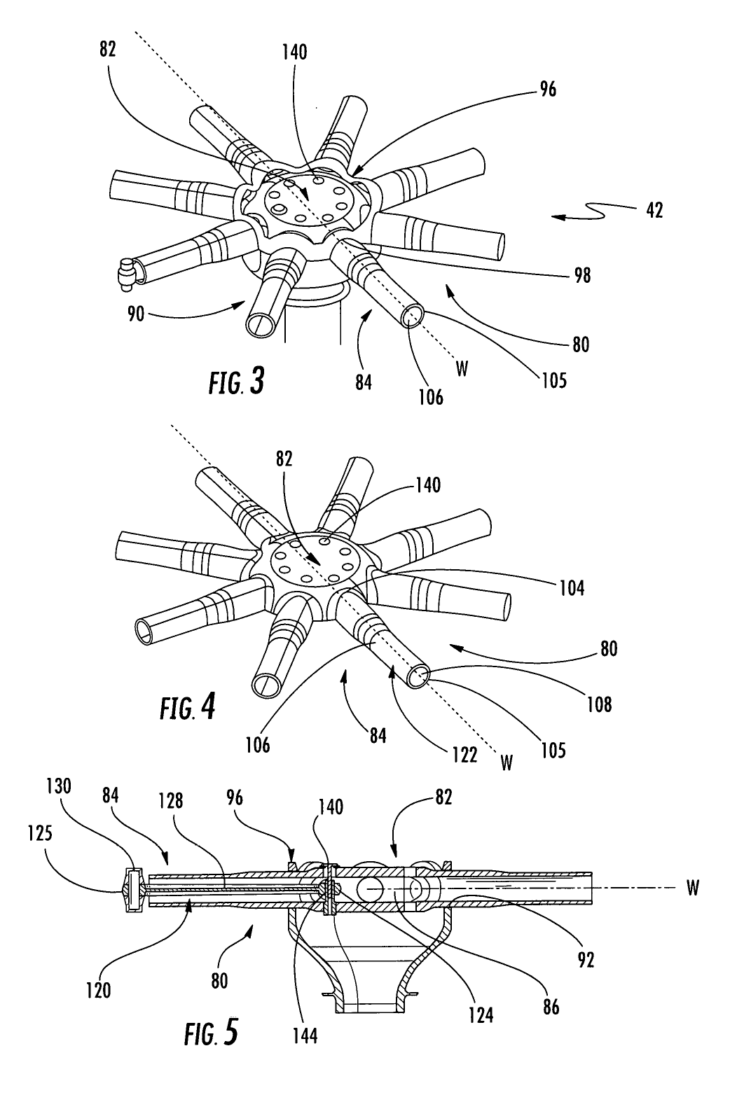

In accordance with an exemplary embodiment illustrated in FIGS. 3-5, propeller assembly 42 includes a one-piece molded rotor hub 80 including a central hub 82 and a plurality of hollow spindles, one of which is indicated at 84. Central hub 82 includes a hollow interior portion 86 (FIG. 5) and is mounted to a drive member 90 which, in turn, is operatively connected to engines 24. Drive member 90 includes a plurality of recesses, one of which is indicated at 92, which receive corresponding ones of hollow spindles 84. One-piece molded rotor hub 80 is secured to drive member 90 by a clamshell member 96 having a plurality of recessed portions 98. Recessed portions 98 align with recesses 92 to encircle each of hollow spindles 84. Clamshell member 96 may be secured to drive member 90 through a variety of techniques known in the art.

Each hollow spindle 84 includes a first end portion 104, a second end portion 105 and an intermediate section 106 extending therebetween. A central passage 108 extends from hollow interior 86, through intermediate section 106 to second end portion 105. Central passage 108 includes a longitudinal axis “w”. A tension torsion strap 120 extends through central passage 108 along longitudinal axis “w”. Tension torsion strap may be similar to the tension torsion strap described in corresponding U.S. Patent Application 62/174,275 entitled “Tension Torsion Strap” filed on Jun. 11, 2015, the disclosure of which is incorporated by reference. In accordance with an aspect of an exemplary embodiment, one or more sleeves 122 may extend over hollow spindle 84 along central passage 108 to improve wear resistance of one-piece molded rotor hub 80. In accordance with an aspect of an exemplary embodiment, metal sleeves 122 may be formed from steel. Of course, it should be understood that other materials may also be employed.

Tension torsion strap 120 includes a first end 124, a second end 125 and an intermediate portion 128 extending therebetween. Second end 125 includes a blade attachment member 130 that operatively connects with one of blades 43. First end 124 is secured within hollow interior 86 of central hub 82. More specifically, a plurality of openings, one of which is indicated at 140, extends through central hub 82. Openings 140 may extend axially through central hub 82 or at an angle relative thereto and are aligned with longitudinal axis “w” of each hollow spindle 84. A pin 144 extends through each opening 140 and engages with first end 124 of each tension torsion strap 120. As such, even while the propeller assembly 42 rotates, each rotor blade 43 is retained by the corresponding tension torsion strap 120.

In accordance with an aspect of an exemplary embodiment, one-piece molded rotor hub 80 is formed from a composite resin. In accordance with another aspect of an exemplary embodiment, one-piece molded rotor hub 80 is formed from a composite resin including a graphite constituent and an epoxy constituent. The particular constituents of the composite resin may vary depending upon various design, operational envelope and other considerations. One-piece molded rotor hub 80 may be formed by a resin transfer mold (RTM) process. However, one of ordinary skill in the art would recognize that there exist various processes for forming one-piece molded rotor hub 80.

At this point, it should be understood that exemplary embodiments describe a one-piece molded rotor hub for an aircraft. The one-piece molded rotor hub is formed from a lightweight, structural material capable of supporting loads associated with rotating blades at a reduced weight over that of previous designs. Further, the use of the clamshell member to secure the propeller assembly to the aircraft reduces installation time, complexity and maintenance issues. Further, exemplary embodiments provide a one-piece molded rotor hub that is easy to manufacture that reacts to system centrifugal forces and blade-to-blade loads while only transmitting thrust, torque and head moment to the drive member.

The terminology used herein is for the purpose of describing particular embodiments only and is not intended to be limiting of the present disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

While the present disclosure has been described with reference to an exemplary embodiment or embodiments, it will be understood by those skilled in the art that various changes may be made and equivalents may be substituted for elements thereof without departing from the scope of the present disclosure. In addition, many modifications may be made to adapt a particular situation or material to the teachings of the present disclosure without departing from the essential scope thereof. Therefore, it is intended that the present disclosure not be limited to the particular embodiment disclosed as the best mode contemplated for carrying out this present disclosure, but that the present disclosure will include all embodiments falling within the scope of the claims.

What is claimed is:

1. A rotor assembly for use with rotor blades and a drive shaft, the rotor assembly comprising:
a one-piece molded rotor hub including a central hub and a plurality of hollow spindles integrally molded with and extending radially outwardly of the central hub to which rotor blades are attachable, the central hub including a hollow interior that is receptive to a drive shaft configured to rotate the one-piece molded rotor hub.

2. The rotor assembly according to claim 1, further comprising: a tension torsion strap extending through each of the plurality of hollow spindles, the tension torsion strap including a first end operatively connected to the central hub and a second end projecting proudly of the corresponding one of the plurality of hollow spindles.

3. The rotor assembly according to claim 1, further comprising: a plurality of openings extending through the central hub, each of the plurality of openings being arranged along a central axis of a corresponding one of the plurality of hollow spindles.

4. The rotor assembly according to claim 3, further comprising: a pin member extending through each of the plurality of openings and operatively connected to the first end of the tension strap arranged in the corresponding one of the plurality of hollow spindles.

5. The rotor assembly according to claim 2, wherein the rotor blade is operatively coupled to the second end of the tension torsion strap.

6. The rotor assembly according to claim 1, further comprising: at least one sleeve installed over each of the plurality of hollow spindles.

7. The rotor assembly according to claim 6, wherein the at least one sleeve is formed from a different material from that which forms the one-piece molded rotor hub.

8. The rotor assembly according to claim 1, further comprising: a clam shell connected to the one-piece molded rotor hub and having openings through each the plurality of hollow spindles extend, the clam shell having a fastening system which connects the one-piece molded rotor hub to the drive shaft.

9. The rotor assembly according to claim 1, wherein the one-piece molded rotor hub assembly is produced formed from a resin composite.

10. The rotor assembly according to claim 9, wherein the resin composite includes one of graphite and an epoxy, and the one-piece molded rotor hub and plurality of hollow spindles are formed as a single molded rotor assembly using a resin transfer molding process.

11. The rotor assembly according to claim 1, wherein the one-piece molded rotor hub and spindles are produced using a process which produces an integrally formed rotor hub.

12. An aircraft comprising:
an airframe;
a power source;
a drive member operatively connected to the power source; and
a rotor assembly operatively connected to the drive member, the one-piece molded rotor hub assembly comprising:
a one-piece molded rotor hub including a central hub and a plurality of hollow spindles integrally molded with and extending radially outwardly of the central hub to which rotor blades are attachable, the central hub including a hollow interior that is receptive to a drive shaft coupled to the drive member.

13. The aircraft according to claim 12, further comprising: a tension torsion strap extending through each of the plurality of hollow spindles, the tension torsion strap including a first end operatively connected to the central hub and a second end projecting proudly of the corresponding one of the plurality of hollow spindles.

14. The aircraft according to claim 12, further comprising:
a plurality of openings extending through the central hub, each of the plurality of openings being arranged along a central axis of a corresponding one of the plurality of hollow spindles;
a pin member extending through each of the plurality of openings and operatively connected to the first end of the tension strap arranged in the corresponding one of the plurality of hollow spindles; and
a rotor blade operatively connected to the second end of the tension torsion strap.

15. The aircraft according to claim 11, further comprising: a clam shell connected to the one-piece molded rotor hub and having openings through each the spindles extend, the clam shell having a fastening system which connects the rotor hub to the drive shaft.
